(19) United States
(12) Patent Application Publication
(10) Pub. No.: US 2018/0305255 A1
(43) Pub. Date: Oct. 25, 2018

(54) Steel Fiber-Reinforced Rubberized Concrete

(71) Applicant: University of Alaska Anchorage, Anchorage, AK (US)

(72) Inventor: Osama A. Abaza, Anchorage, AK (US)

(21) Appl. No.: 15/874,578

(22) Filed: Jan. 18, 2018

Related U.S. Application Data
(60) Provisional application No. 62/447,660, filed on Jan. 18, 2017.

(51) Int. Cl. C04B 14/48; C04B 18/22; C04B 20/00; C04B 7/02; E04C 5/01

(52) U.S. Cl. CPC C04B 14/48; C04B 18/22; C04B 2103/0014; C04B 7/02; E04C 5/012; C04B 20/0016

(57) ABSTRACT

Disclosed is a concrete mixture comprising an amount of coarse aggregate, an amount of cement, an amount of crumb rubber, and an amount of steel fibers. Also disclosed are methods for the manufacture of same.

### CROSS REFERENCE TO RELATED APPLICATIONS

This application claims the benefit of priority to copending U.S. provisional patent application 62/447,660, filed Jan. 18, 2017. The entire disclosure of each of the aforementioned patent applications is incorporated by reference herein.

### BACKGROUND

The use of Portland cement concrete (PCC) pavement in cold regions has been limited due to extreme changes in temperature and dissimilar frost action. Inclusion of rubber in concrete composite enhances the composite with higher elasticity, but results in lower strength. Additional measures are required to compensate for the reduced strength of rubberized concrete (RC).

### SUMMARY

It is to be understood that both the following general description and the following detailed description are exemplary and explanatory only and are not restrictive. In accordance with the purpose(s) of the invention, as embodied and broadly described herein, the disclosure, in one aspect relates to a steel fiber-reinforced concrete product concrete mixture comprising: an amount of coarse aggregate; an amount of cement; an amount of crumb rubber; and an amount of steel fibers.

In another aspect, disclosed herein is a method for creating a concrete product comprising: adding course aggregate and a portion of an amount of mixing water to create a mixture; adding crumb rubber to the mixture; adding cement and a remainder of the amount of mixing water to the mixture; and adding steel fibers to the mixture.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a graph depicting grading curves of aggregates and crumb rubber according to a sieve analysis;

FIG. 2 is a depiction of geometry of a test specimen and test setup;

FIG. 3 is an image of internal and external data acquisition units;

FIG. 4 is a graph depicting a load-deflection curve; and

FIG. 5 is a flowchart describing an exemplary method.

### DETAILED DESCRIPTION

The present invention can be understood more readily by reference to the following detailed description, examples, and claims, and their previous and following description. However, before the present compositions, articles, devices, systems, and/or and methods are disclosed and described, it is to be understood that the methods and systems are not limited to specific compositions, articles, devices, systems, and/or methods, specific components, or to particular implementations disclosed unless otherwise specified, as such can, of course, vary. It is also to be understood that the terminology used herein is for the purpose of describing particular embodiments only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited

As used in the specification and the appended claims, the singular forms “a,” “an” and “the” include plural referents unless the context clearly dictates otherwise. Thus, for example, reference to a “mixture” includes aspects having two or more mixtures unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. It is further understood that the term “comprising” may include the aspects “consisting of” and “consisting essentially of.” “Exemplary” means “an example of” and is not intended to convey an indication of a preferred or ideal embodiment. “Such as” is not used in a restrictive sense, but for explanatory purposes. Unless defined otherwise, all technical and scientific terms used herein have the same meaning as commonly understood by one of ordinary skill in the art to which this invention belongs. In this specification and in the claim which follow, reference will be made to a number of terms which shall be defined herein.

The term “Flexural load-deflection curve” as described herein, refers to a plot of load versus net deflection of a beam specimen loaded to the first-crack load. In such exemplary aspects where the flexural load deflection curve is used, a flexural load-deflection curve scale is such that 1 inch (2.54 cm) corresponds to a 0.012 inch (0.3 cm) net deflection and 2,000 pound force (lbf) (909 kg force) load

The term “First-crack load (P₁)” as described herein, refers to the load value at the first point on the flexural load-deflection curve when nonlinearity becomes apparent.

The term “Proportional limit (PL)” as described herein, refers to the point when the flexural load-deflection curve deviation from linearity becomes apparent.

The term “First-crack strength (f₁)” as described herein refers to the stress value obtained at the first-crack load.

As described herein, the term “First-crack net deflection (o′₁)” refers to the net deflection value obtained on the flexural load-deflection curve at the first-crack load.

As described herein, the term “Net deflection” refers to the deflection measured at the mid-span of a specimen exclusive of any extraneous movements due to seating, twisting, or deformation of supports.

As described herein, the term “First-crack toughness” refers to a measure of the area under the flexural load-deflection curve at the first-crack net deflection.

Disclosed are components that can be used to perform the disclosed methods and compositions. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and compositions. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

The disclosed mixture comprises an aggregate. As used herein, the term “aggregate” refers to a broad category of coarse to fine grained particulate material used in construction, including, but not limited to, sand, gravel, crushed stone, slag, recycled concrete, geosynthtic aggregates, and any combination thereof. It is understood that the term “maximum aggregate size” as used herein refers to the smallest sieve opening which the entire amount of aggregate is required to pass. In certain aspects, the aggregates are coarse aggregates having a maximum size of about 3.5 inch (about 9 cm) to about ¾ inch (1.91 cm), including exemplary values of about 2.5 inch (about 6.3 cm), about 2 inch (about 5.08 cm), about 1.5 inch (3.75 cm), about 1 inch (2.54 cm). In yet other aspects, the coarse aggregates are aggregates having a maximum size of about 1 inch (2.54 cm).

It is understood that the coarse aggregates can also contain aggregates having a maximum size smaller than about 1 inch. In yet other aspects, the aggregates are intermediate aggregates having a maximum size of about 0.75 inch (about 1.91 cm), about 0.5 inch (1.25 cm), or about 0.375 inch (about 0.95 cm). In yet other aspects, the maximum size of the intermediate aggregates is about 0.5 inch (1.25 cm). Again, it is understood that intermediate aggregates can also contain aggregates having a size smaller than about 0.5 inch (1.25 cm). In still further aspects, the aggregates are the fine aggregates if the maximum aggregate size is from about 0.375 inch (0.95 cm), or equivalent to sieve No. 4 (0.475 cm), or equivalent to sieve No. 8 (0.236 cm). In still further aspects, the aggregates used herein were defined as fine aggregates if the total percent by weight is passing No. 4 (0.475 cm) sieve. In certain aspects, the aggregates used herein can comprise an amount of organic impurities, in yet other aspects, the aggregated used herein do not comprise organic impurities. It is also understood that the fine aggregates as used herein do not comprise organic impurities. It is further understood that the water absorption capacity of the aggregates is dependent on a type of the aggregates and can range from about 0.79% for coarse aggregates, to about 0.87% to intermediate aggregates, and to about 1.23% for fine aggregates.

In some aspects, the mixtures disclosed herein are prepared as a batch. In some aspects, the batch volume can be any volume chosen by the one of ordinary skill in the art. In some exemplary aspects, the batch volume can be from about 1.06 cu ft (about 0.03 m³) to about 317.8 cu ft (about 9 m³) including, exemplary values of about 2.01 cu ft (about 0.06 m³), about 3.5 cu ft (about 0.1 m³), about 7.06 cu ft (about 0.2 m), about 17.66 cu ft (about 0.5 m³), about 26.49 cu ft (about 0.75 m³), about 35.3 cu ft (about 1 m³), about 70.63 cu ft (about 2 m³), about 105.94 cu ft (about 3 m³), about 141.26 cu ft (about 4 m³), about 176.57 cu ft (about 5 m³), about 211.89 cu ft (about 6 m³), about 247.20 cu ft (about 7 m³), and about 282.52 cu ft (about 8 m³). It is further understood that the batch volume can be any volume described herein, for example, batch volume can be from about 1.06 cu ft (0.03 m³) to about 17.66 cu ft (about 0.5 m³), or from about 26.49 cu ft (about 0.75 m³) to about 105.94 cu ft (about 3 m³), or from about 70.63 cu ft (about 2 m³) to about 211.89 cu ft (about 6 m), or from about 105.94 cu ft (about 3 m³) to about 317.8 cu ft (about 9 m³). In some exemplary aspects described herein, the batch volume can be 2.01 cu ft (0.06 m³).

In certain aspects as described herein, some of the components, for example, an aggregate, steel fibers, or cement, are added in the units of lbs per batch volume. In other aspects, water is added in the units of ml per batch volume.

In certain aspects, the amount of the coarse aggregate present in the disclosed concrete mixture is from about 100 lbs/batch volume to about 180 lbs/batch volume, including exemplary values of about 105 lbs/batch volume, about 110 lbs/batch volume, about 115 lbs/batch volume, about 120 lbs/batch volume, about 125 lbs/batch volume, about 130 lbs/batch volume, about 135 lbs/batch volume, about 140 lbs/batch volume, about 145 lbs/batch volume, about 150 lbs/batch volume, about 155 lbs/batch volume, about 160 lbs/batch volume, about 165 lbs/batch volume, and about 170 lbs/batch volume. In still further aspects, the amount of coarse aggregate can be any amount between two foregoing values. For example, the coarse aggregate can be present in an amount from about 135 lbs/batch volume to about 145 lbs/batch volume, including exemplary values of about 136 lbs/batch volume, about 137 lbs/batch volume, about 138 lbs/batch volume, about 139 lbs/batch volume, about 140 lbs/batch volume, about 141 lbs/batch volume, about 142 lbs/batch volume, about 143 lbs/batch volume, and about 144 lbs/batch volume.

In still further aspects, the mixture described herein can comprise an amount of intermediate aggregate. In yet other aspects, the mixture described herein can comprise an amount of fine aggregate. In still further aspects, the mixture described herein can comprise an amount of intermediate aggregate or an amount of fine aggregate.

In the aspects wherein the intermediate aggregate is present, the intermediate aggregate can be present in an amount from about 10 lbs/batch volume to about 20 lbs/batch volume, including exemplary values of about 11 lbs/batch volume, about 12 lbs/batch volume, about 13 lbs/batch volume, about 14 lbs/batch volume, about 15 lbs/batch volume, about 16 lbs/batch volume, about 17 lbs/batch volume, about 18 lbs/batch volume, and about 19 lbs/batch volume. In yet other aspects, the intermediate aggregate can be present in any amount between any foregoing values. For example and without limitation, the intermediate aggregate can be present in an amount from about 10 lbs/batch volume to about 12 lbs/batch volume, or from about 13 lbs/batch volume to about 14 lbs/batch volume, or from about 13 lbs/batch volume to about 15 lbs/batch volume.

In the aspects wherein the fine aggregate is present, the fine aggregate can be present in an amount from about 30 lbs/batch volume to about 100 lbs/batch volume, including exemplary values of about 35 lbs/batch volume, about 40 lbs/batch volume, about 45 lbs/batch volume, about 50 lbs/batch volume, about 55 lbs/batch volume, about 60 lbs/batch volume, about 65 lbs/batch volume, about 70 lbs/batch volume, about 75 lbs/batch volume, about 80 lbs/batch volume, about 85 lbs/batch volume, about 90 lbs/batch volume, and about 95 lbs/batch volume. In yet other aspects, the intermediate aggregate can be present in any amount between any foregoing values. For example and without limitation, the intermediate aggregate can be present in an amount from about 40 lbs/batch volume to about 90 lbs/batch volume.

In still further aspects, the mixture disclosed herein can comprise any cement known in the art. In certain aspects, cement described herein is hydraulic. In yet other aspects, the cement described herein is non-hydraulic. In some aspects, the cement can comprise a slaked lime or calcium oxide mixed with water, or it can comprise a mixture of silicates and oxides. In some aspects, the cement of the disclosed mixture can comprise belite (2CaO.SiO₂), alite (3CaO.SiO₂), tri-calcium aluminate (3CaO.Al₂O₃), brownmilerite (4CaO.Al₂O₃.Fe₂O₃), or any combination thereof. In some aspects, the cement of the disclosed mixture is Portland cement. In yet other aspects, the disclosed mixture can comprise cement in an amount from about 30 lbs/per batch volume to about 60 lbs/per batch volume, including exemplary values of about 32 lbs/per batch volume, about 35 lbs/per batch volume, about 37 lbs/per batch volume, about 40 lbs/per batch volume, about 43 lbs/per batch volume, about 45 lbs/per batch volume, about 47 lbs/per batch volume, about 50 lbs/per batch volume, about 53 lbs/per batch volume, about 55 lbs/per batch volume, and about 57 lbs/per batch volume. It is understood that the cement can be present in any amount between any two foregoing values.

In still further aspects, the crumb rubber present in the disclosed mixture can comprise any types of rubber known in the art. In certain aspects, the crumb rubber comprises a waste rubber. Some exemplary examples of the crumb rubber comprise scrap tires. In yet other aspects, the crumb rubber is a cryogenic crumb rubber. In certain aspects, the crumb rubber can be present in the disclosed mixture in an amount greater than 0% of the concrete mixture by total volume to about 75% of the concrete mixture by total volume, including exemplary values of about 10% of the concrete mixture by total volume, about 15% of the concrete mixture by total volume, about 20% of the concrete mixture by total volume, about 25% of the concrete mixture by total volume, about 30% of the concrete mixture by total volume, about 35% of the concrete mixture by total volume, about 40% of the concrete mixture by total volume, about 45% of the concrete mixture by total volume, about 50% of the concrete mixture by total volume, about 55% of the concrete mixture by total volume, about 60% of the concrete mixture by total volume, about 65% of the concrete mixture by total volume, and about 70% of the concrete mixture by total volume. In certain aspects, the maximum size of crumb rubber particles can be about 0.1 inch (about 0.254 cm), about 0.15 inch (about 0.381 cm), about 0.2 inch (about 0.508 cm), about 0.25 inch (about 0.635 cm), about 0.3 inch (about 0.762 cm), or about 0.35 inch (about 0.889 cm).

In still further aspects, the disclosed mixture can comprise an amount of steel fibers. Any fibers that meet the industry requirements can be used. In certain aspects, the composition of the steel fibers can vary to a large extent. In certain aspects, the steel fibers comprise a minimum carbon content of at least about 0.40%, or at least about 0.80%, or at least about 0.96%. In yet other aspects, the steel fibers can comprise manganese content from about 0.20% to about 0.90%, including exemplary values of about 0.30%, about 0.40%, about 0.50%, about 0.60%, about 0.70%, and about 0.80%. In still further aspects, the steel fibers can comprise silicon in an amount of about 0.10 l/o to about 0.90%, including exemplary values of about 0.20%, about 0.30%, about 0.40%, about 0.50%, about 0.60%, about 0.70%, and about 0.80%. In still further aspects, the steel fibers can also comprise sulfur and/or phosphorous. In the aspects wherein sulfur and/or phosphorous are present, the amount of each component can be less than about 0.05%, less than about 0.03%, or less than about 0.01%. In still further aspects, additional elements such as chromium, boron, cobalt, nickel, vanadium, and the like can be added to the steel fibers composition in order to reduce the degree of reduction required for obtaining a particular tensile strength.

In still further aspects, the steel fibers disclosed herein have a tensile strength from about 900 MPa to about 2,000 MPa, including exemplary values of about 950 MPa, about 1,000 MPa, about 1,050 MPa, about 1,100 MPa, about 1,150 MPa, about 1,200 MPa, about 1,250 MPa, about 1,300 MPa, about 1,350 MPa, about 1,400 MPa, about 1,450 MPa, about 1,500 MPa, about 1,550 MPa, about 1,600 MPa, about 1,650 MPa, about 1,700 MPa, about 1,750 MPa, about 1,800 MPa, about 1,850 MPa, about 1,900 MPa, and about 1,950 MPa.

In still further aspects, the steel fibers described herein have a length from about 30 mm to about 90 mm, including exemplary values of about 40 mm, about 50 mm, about 60 mm, about 70 mm, and about 80 mm. In still further aspects, the fibers described herein have a diameter from about 0.2 mm to about 3 mm, including exemplary values of about 0.5 mm, about 0.7 mm, about 1 mm, about 1.2 mm, about 1.5 mm, about 1.7 mm, about 2 mm, about 2.2 mm, about 2.5 mm, and about 2.7 mm.

In still further aspects, the steel fibers described herein can have an aspect ratio of about 30, about 40, about 50, about 60, or about 70. The steel fibers of the current disclosure can be provided as flat ended (FE) or hooked ended (HE). In yet other aspects, the steel fibers can be provided with a coating. In some aspects, the coating can be a metallic coating. In some exemplary and non-limiting aspects the coating can be a copper alloy coating, or zinc coating, or aluminum coating.

Some exemplary steel fibers can be purchased from Propex Fibermesh® that are sold under a trade name Novocon 1050, formerly known as Novotex 1050. The steel fibers can be present in the disclosed mixture in an amount from about 5 lbs/batch volume to about 15 lbs/batch volume, including exemplary amounts of about 6.3 lbs/batch volume, about 8.8 lbs/batch volume, and about 12.6 lbs/batch volume. In such aspects, the steel fibers can be present in an amount from about 0.5% of the concrete mixture by total volume to about 1.5% of the concrete mixture by total volume, including exemplary values of about 0.64% of the concrete mixture by total volume, about 0.89% of the concrete mixture by total volume, and about 1.28% of the concrete mixture by total volume.

In still further aspects, the crumb rubber and the steel fibers can be present in the concrete mixture in any combination and comprise any amounts disclosed above. For example, in some aspects, the concrete mixture can comprise the crumb rubber an amount greater than 0% of the concrete mixture by total volume to about 75% of the concrete mixture by total volume and the steel fibers in an amount from about 0.5% of the concrete mixture by total volume to about 1.5% of the concrete mixture by total volume, including exemplary amounts of the crumb rubber of about 10% of the concrete mixture by total volume, about 15% of the concrete mixture by total volume, about 20% of the concrete mixture by total volume, about 25% of the concrete mixture by total volume, about 30% of the concrete mixture by total volume, about 35% of the concrete mixture by total volume, about 40% of the concrete mixture by total volume, about 45% of the concrete mixture by total volume, about 50% of the concrete mixture by total volume, about 55% of the concrete mixture by total volume, about 60% of the concrete mixture by total volume, about 65% of the concrete mixture by total volume, and about 70% of the concrete mixture by total volume; and exemplary amounts of the steel fibers of about 0.64% of the concrete mixture by total volume, about 0.89% of the concrete mixture by total volume, and about 1.28% of the concrete mixture by total volume.

In still further aspects, the concrete mixture further comprises water. Water can be present in an amount of about 15 lbs/batch volume to about 25 lbs/batch volume, including exemplary values of about 16 lbs/batch volume, about 17 lbs/batch volume, about 18 lbs/batch volume, about 19 lbs/batch volume, about 20 lbs/batch volume, about 21 lbs/batch volume, about 22 lbs/batch volume, about 23 lbs/batch volume, and about 24 lbs/batch volume. In still further aspects, water and cement are present in the concrete mixture in a ratio from about 0.5 to about 0.3, including exemplary values of about 0.49, about 0.48, about 0.47, about 0.46, about 0.45, about 0.44, about 0.43, about 0.42, about 0.41, about 0.4, about 0.39, about 0.38, about 0.37, about 0.36, about 0.35, about 0.34, about 0.33, about 0.32, and about 0.31.

In still further aspects, the concrete mixture comprises an amount of water reducing admixture. As used herein, the term “admixture” is defined as a material other than water, aggregates, cement or fiber reinforcement that is used as an ingredient of a concrete mixture to modify its freshly mixed, setting or hardened properties and that is added to the batch before or during mixing. As one of ordinary skill in the art would readily appreciate, the purpose of water reducing admixtures is to reduce the amount of mixing water required to obtain a given slump. In such aspects, a reduction of the water-cement ratio (w/c ratio) is obtained, which leads to increased strengths and more durable concrete. In yet other aspects, water-reducing admixtures also reduce segregation and improve the flowability of the concrete. As one of ordinary skill in the art would readily appreciate, water-reducing admixtures are commonly fall into three groups: low-, medium- and high-range. These groups are based on the range of water reduction for the admixture. For example, low-range water reducers reduce w/c ratio, with % of water reduction from about 5 to about 10%, and increase slump, with the slump range from about 4-5 inches. The mid-range water reducer reduces water by 10-15%, increase slump to about 5-8 inches, reduce stickiness, improve finishability, pumpability, etc. The high range water reducers reduce water content by 12-30+%, increase slump range to 8 inches or greater, produce high-strength and/or high-performance concrete for heavily reinforced members or where consolidation is difficult.

As one of ordinary skill in the art would readily appreciate, when cement comes in contact with water, dissimilar electrical charges at the surface of the cement particles attract one another, which results in flocculation or grouping of the particles. A good portion of the water is absorbed in this process, thereby leading to a cohesive mix and reduced slump. Without wishing to be bound by a theory, added water-reducing admixtures essentially neutralize surface charges on solid particles and cause all surfaces to carry like charges. Since particles with like charges repel each other, they reduce flocculation of the cement particles and allow for better dispersion. They also reduce the viscosity of the paste, resulting in a greater slump.

Any known in the art water reducing admixtures can be utilized. For example and without limitation, the low-range water reducing admixtures can comprise lignosulfates, hydroxylated carboxylic acids, and carbohydrates. In other exemplary and not limiting aspects, the mid-range water reducers can comprise lignosulfates and polycarboxylates. In certain aspects, the polycarboxylates described herein encompass a homopolymer, a copolymer, and any combination thereof comprising a polycarboxylic group to which other functional groups can be bonded. Preferably, these other functional groups are capable of attaching to cement particles and other functional groups for dispersing the attached cement particle within an aqueous environment. Specifically, polycarboxylates are polymers with a carbon backbone having pendant side chains with the characteristic that at least a portion of the side chains are attached to the carbon backbone through a carboxyl group or an ether group. An exemplary mid-range water reducer can be purchased from BASF Construction Chemicals, LLC, Cleveland, Ohio sold under a trade name of PolyHeed 997. Yet, in other exemplary and not limiting aspects, the high-range water reducers can comprise formaldehyde condensates of at least one compound selected from the group consisting of methylolation and sulfonation products of each of naphthalene, melamine, phenol, urea, and aniline, examples of which include metal naphthalenesulfonate-formaldehyde condensates, metal melaminesulfonate-formaldehyde condensates, phenolsulfonic acid-formaldehyde condensate, and phenol-sulfanilic acid-formaldehyde co-condensates, lignosulfates, polycarboxylates. In certain aspects, the water reducing admixture can be added to an amount of mixing water prior to addition to the mixture. In yet other aspects, the water reducing admixture can be added to the concrete mixture after all the components are already have been added to the mixture. In the aspects where high-range water reducing admixtures are used, the admixture can be added at the job site prior to placement.

In yet other aspects, the amount of water reducing admixture is described as a dosage. The term “dosage” as described herein refers to a measure of a volume of the water reducer added per hundred pounds of cement. In certain exemplary and non-limiting aspects, the dosage can be provided as 206.99 ml/100 lbs weight of cement or 443.55 ml/100 lbs weight of cement.

Methods

In yet other aspects disclosed here are also methods for creating a concrete product. In such aspects, the method comprises adding course aggregate and a portion of an amount of mixing water to create a mixture; adding crumb rubber to the mixture, adding cement and a remainder of the amount of mixing water to the mixture, and adding steel fibers to the mixture.

In still further aspects, the method further comprises adding a water-reducing admixture to the amount of mixing water prior to addition to the mixture. Any amounts and types of the water reducing admixtures described herein can be added to the mixing water. In still further aspects, the method further comprises adding an amount of intermediate aggregate or an amount of fine aggregate to the mixture. Any of disclosed intermediate or fine aggregates can be utilized. In yet other aspects, the amount of intermediate aggregate or the amount of fine aggregate are added to the mixture with the coarse aggregate. In yet other aspects, the amount of the fine aggregate can be added with a crumb rubber. In still further aspects, the crumb rubber can be present in any amount described herein. In still further aspects, the steel fibers can be present in any amount described herein. The volume of batch sample can be readily determined by one of ordinary skill in the art based on the required application.

In yet other aspects, the method further comprises mixing the mixture in a mixing drum. Any known in the art mixing drums can be utilized. In still further aspects, the method further comprises casting the mixture.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### Examples

The following exemplary aspects relate to a steel fiber-reinforced rubberized concrete (SFRRC) product. In certain aspects, two main components were analyzed: experimental and analytic. In some exemplary aspects, the experimental component comprises two parts: (1) material tests; and (2) structural tests. In other exemplary aspects, tests were conducted to establish fresh mix and constituent material properties to verify their consistence with the ASTM and ACI standard tests as they pertain to Portland cement concrete (PCC) or steel fiber-reinforced concrete (SFRC), when applicable. In exemplary aspects, flexural tests were conducted (using a four-point loading configuration) on three PCC, nine rubberized concrete (RC), nine SFRC, and twenty seven SFRRC concrete beams samples. In other exemplary aspects, cylindrical compressive tests were also conducted for SFRRC mixes.

In exemplary aspects comprising the analytic component, statistical methods can be used to analyze the experimental results. In such aspects, the behavior of PCC, RC, FRC, and SFRRC concrete mixes has been analyzed by the methods disclosed herein.

In one exemplary aspect, aggregates can be used in their normal moisture conditions. In yet other exemplary aspects, aggregates can be mixed and scaled to provide a uniform distribution and prevent any moisture change. The physical properties of the exemplary coarse, intermediate, and fine aggregates used in the samples prepared herein are listed in Table 1 below.

TABLE 1
Physical Properties of Aggregates

| Aggregate type | Coarse | | Intermediate | | Fine |
|---|---|---|---|---|---|
| Maximum size [in. (cm)] | 1 | (2.54) | 0.50 | (1.27) | No. 4 (0.475) |
| Fineness modulus | NA^{a} | | NA^{a} | | 2.749 |
| Specific gravity (saturated | 2.724 | | 2.739 | | 2.714 |
| surface dry) | | | | | |
| Unit weight, [lb/cu ft (kg/m³)] | 110.2 | (1,766) | 106.25 | (1,700) | NA^{a} |

| | | | |
|---|---|---|---|
| Los Angeles abrasion value (%) | 13.97 | 13.52 | NA^{a} |
| Water absorption capacity (%) | 0.79 | 0.87 | 1.23 |
| Presence of organic impurities | NA^{a} | NA^{a} | None |
| Clay lump (%) | 0.19 | 0.05 | 0.00 |
| Soundness (%) | 1.7 | 2.0 | 2.3 |

^{a}Not applicable for this test method.

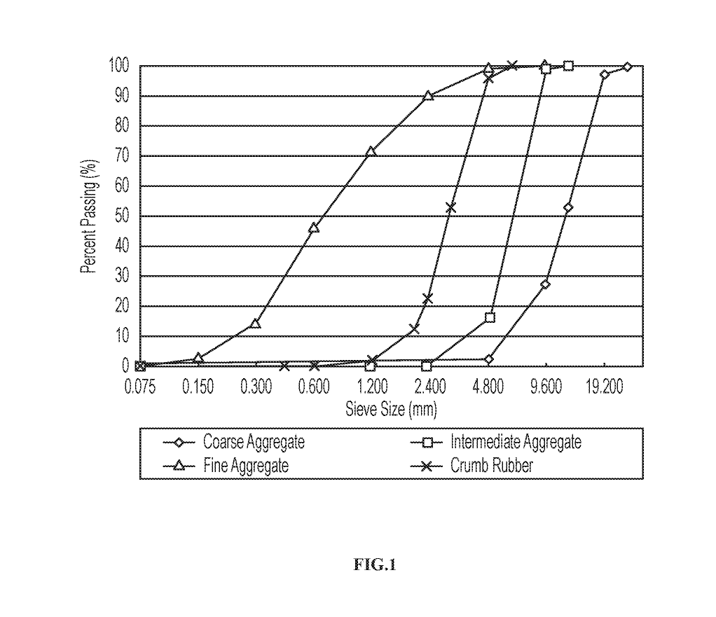

In exemplary aspects, cryogenic crumb rubber can be used as a replacement of fine aggregate an amount of 15, 35, and 50% by volume. It is understood that the particle size distribution of crumb rubber can be determined in accordance with ASTM C136 (ASTM 2006b). In exemplary and not limiting aspects described herein, the maximum size of the added crumb rubber can be about 0.25 inch (about 0.635 cm). Exemplary aggregates and crumb rubber grading curves obtained from the sieve analysis are shown in FIG. 1, depicting grading curves of exemplary aggregates and crumb rubber.

Flat-end (FE) steel fibers exhibiting tensile strength of about 1,050 MPa (152,000 psi) can be included in the SFRRC. Novocon 1050 steel fibers were used herein as exemplary steel fibers present in the concrete mixture. Novocon 1050 fibers meet ASTM A820 (ASTM 2006a) requirements for Type I cold drawn wire. In yet other aspects, a mid-range water reducer can be added to the mixture. An exemplary mid-range water reducer can be purchased from BASF Construction Chemicals, LLC, Cleveland, Ohio sold under a trade name of PolyHeed 997. PolyHeed 997 meets ASTM C494 (ASTM 2008a) requirements for Type A, water-reducing admixtures and can be used at two different dosage rates that are described above. In certain aspects, PolyHeed 997 can be added to the mixing water before starting the batch cycle.

In some aspects, and as appreciated by the skilled practitioner, the standard ACI 211.1-91 (ACI 2002) absolute volume method can be utilized to determine mixture proportioning.

A control concrete matrix was designed with a 28-day compressive strength in the range of about 34.5 to about 41.4 MPa (about 5,000 to about 6,000 psi), including exemplary values about 35.2 MPa, about 35.9 MPa, about 36.5 MPa, about 37.2 MPa, about 37.9 MPa, about 38.6 MPa, about 39.3 MPa, about 40.0 MPa, about 40.7 MPa (about 5,100 psi, about 5,200 psi, about 5,300 psi, about 5,400 psi, about 5,500 psi, about 5,600 psi, about 5,700 psi, about 5,800 psi, and about 5,900 psi). To determine workability, consolidation, design strength, and finishing of the design mix, three trial mixes were developed. For final testing, 16 mixtures were prepared. The following variable parameters: fiber volume fraction, crumb rubber content, aggregates, and water reducing admixture dosage were used in the mixture preparation. The 16 mixtures included one PCC (control mix), three RC, three SFR, and nine SFRRC samples. The exemplary mixture proportions of exemplary concrete mixtures are shown in Table 2 (a-c) below.

TABLE 2
Mix Proportions
(a)

| Parameters | Batch 1 | Batch 2 | Batch 3 | Batch 4 | Batch 5 |
|---|---|---|---|---|---|
| Cement^{a} | 46.5 | 46.5 | 46.5 | 46.5 | 46.5 |
| Water^{a} | 19.0 | 19.0 | 19.0 | 19.0 | 19.0 |
| w/c ratio | 0.41 | 0.41 | 0.41 | 0.41 | 0.41 |
| Coarse aggregate^{a,b} | 141.5 | 141.5 | 141.5 | 141.5 | 140.2 |
| Intermediate aggregate^{a,b} | 13.3 | 13.3 | 13.3 | 13.3 | 13.1 |
| Fine aggregate^{a,b} | 88.9 | 75.6 | 62.3 | 44.5 | 88.1 |
| Polyheed-997^{c} | 96.2^{d} | 96.2^{d} | 96.2^{d} | 96.2^{d} | 96.2^{d} |
| Crumb rubber, % | 0 | 15 | 35 | 50 | 0 |
| Steel fiber^{a,f} | 0 | 0 | 0 | 0 | 6.3 |

(b)

| Parameters | Batch 6 | Batch 7 | Batch 8 | Batch 9 | Batch 10 |
|---|---|---|---|---|---|
| Cement^{a} | 46.5 | 46.5 | 46.5 | 46.5 | 46.5 |
| Water^{a} | 19.0 | 19.0 | 19.0 | 19.0 | 19.0 |
| w/c ratio | 0.41 | 0.41 | 0.41 | 0.41 | 0.41 |
| Coarse aggregate^{a,b} | 139.6 | 138.9 | 139.8 | 139.3 | 138.5 |
| Intermediate aggregate^{a,b} | 13.1 | 13.0 | 13.1 | 13.1 | 13.0 |
| Fine aggregate^{a,b} | 87.8 | 87.3 | 74.7 | 74.4 | 74.0 |
| Polyheed-997^{c} | 96.2^{d} | 96.2^{d} | 206.1^{c} | 206.1^{c} | 206.1^{c} |
| Crumb rubber, % | 0 | 0 | 15 | 15 | 15 |
| Steel fiber^{a,f} | 8.8 | 12.6 | 6.3 | 8.8 | 12.6 |

(c)

| Parameters | Batch 11 | Batch 12 | Batch 13 | Batch 14 | Batch 15 | Batch 16 |
|---|---|---|---|---|---|---|
| Cement^{a} | 46.5 | 46.5 | 46.5 | 46.5 | 46.5 | 46.5 |
| Water^{a} | 19.0 | 19.0 | 19.0 | 19.0 | 19.0 | 19.0 |
| w/c ratio | 0.41 | 0.41 | 0.41 | 0.41 | 0.41 | 0.41 |
| Coarse aggregate^{a,b} | 139.8 | 139.3 | 138.5 | 139.8 | 139.3 | 138.5 |
| Intermediate aggregate^{a,b} | 13.1 | 13.1 | 13.0 | 13.1 | 13.1 | 13.0 |
| Fine aggregate^{a,b} | 61.5 | 61.3 | 61.0 | 43.9 | 43.8 | 43.5 |
| Polyheed-997^{c} | 206.1^{c} | 206.1^{c} | 206.1^{c} | 206.1^{c} | 206.1^{c} | 206.1^{c} |
| Crumb rubber, % | 35 | 35 | 35 | 50 | 50 | 50 |
| Steel fiber^{a,f} | 6.3 | 8.8 | 12.6 | 6.3 | 8.8 | 12.6 |

^{a}Lbs(0.45 kg)/batch volume, batch volume = 2.01 cu ft (0.06 m³).
^{b}Aggregate weight in their natural moisture conditions.
^{c}Milliliter (ml) (0.0033 cu ft)/batch volume.
^{d}Dosage = 206.99 mL (0.0033 cu ft)/100 lbs(0.45 kg) weight cement.
^{c}Dosage = 443.55 mL (0.0033 cu ft)/100 lbs(0.45 kg) weight cement.
^{f}6.3, 8.8, 12.6 lbs (0.45 kg)/batch volume and equal to 0.64, 0.89, and 1.28% volume fractions, respectively.

In certain aspects, to assure uniformity between mixtures, one mixing procedure can be used for all mixes. In yet other aspects, different mixing procedures can be also utilized. In the exemplary aspects described herein, the same mixing procedures were used for all mixtures. As one of ordinary skill in the art would readily understand, any known in the art methods of mixing can be utilized. For example and without limitation, a rotary electric concrete mixer can be used to mix the concrete ingredients. The water-reducing admixture was added to the mixing water prior to mixing. The coarse and intermediate aggregates were placed in a drum with about a quarter of the mixing water, and then the mixer was allowed to run for about 1 min. In sill further aspect, fine aggregates and crumb rubber were then added and mixed for about two minutes. For example, in some aspects, the fine aggregates can comprise sand. In still further aspects, sand and crumb rubber can be added and mixed for about two minutes. Cement and the remaining mixing water were then added and mixed for about 3 min, rested for about 3 min, and mixed for about 2 min as a final stage. For mixes having steel fibers present, an additional 4 min were added to the final stage described above after introducing all mixing fibers. It is understood that the steel fibers can be added using any methods known in the art. In exemplary aspects described herein, steel fibers was sprinkled by hand (i.e., as a rain of individual fibers) on the fluid mix as the last step of batching, while the drum mixer continues to rotate at normal charging speed (according to the guidance issued by the American Association of State Highway and Transportation Officials (AASHTO) in 2001), or according to “Design Consideration for Steel Fiber Reinforced Concrete” as reported by ACI (American Concrete Institute) committee 544 (ACI 544.4R.99 (ACI 1999a)); or according to “Guide for Specifying, Proportioning, Mixing, Placing, and Finishing Steel Fiber Reinforced Concrete as reported by ACI Committee 544 (ACI 544.3R.93 (ACI 1998)); and according to “Measurement of Properties of Fiber Reinforced Concrete” as reported by ACI committee 544 (ACI 544.2R.89 (ACI 1999b)).

Without wishing to be bound by a theory, it is understood that maintaining the rotation of the drum can aid in carrying away the fibers as they enter the mixture, assuring a good dispersion of fibers, and preventing fiber balling.

After mixing, the concrete was emptied into a wheelbarrow and covered with a plastic sheet. The freshly mixed concrete was then tested for temperature, slump, unit-weight, and air-content according to ASTM C1064, ASTM C143, ASTM C138, ASTM C231 (ASTM 2008b) standards, respectively, prior to casting the concrete.

Forty-eight flexural beam specimens [15×15×53 cm (6×6×21 in.)] were casted from the prepared mixtures—three for each of the 16 mixes. Of those, three were PCC (control mix), nine were RC, nine were SFR, and 27 were SFRRC. An additional nine compressive cylinders [15×30 cm (6×12 in.)] were also casted, a total of one each for the SFRRC mixes.

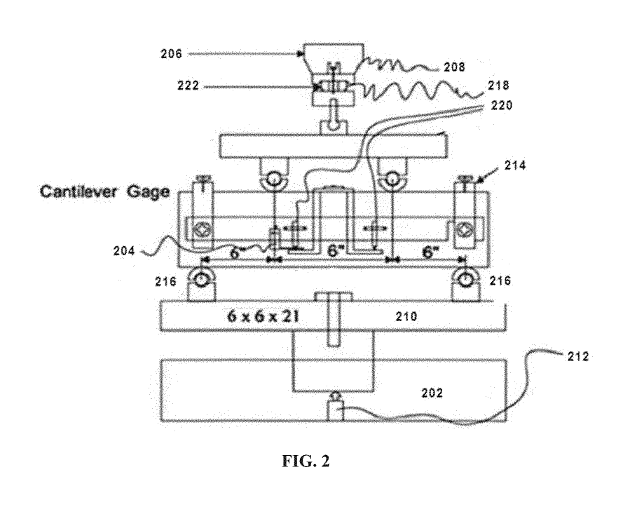

The geometry of the test specimen and test setup are shown in FIG. 2. The flexural tests were performed using a 758 MPa (110 kips) capacity servo-value controlled material testing system (MTS) that ran in displacement control, wherein the MTS system comprises an MTS Base 202, an MTS Data Acquisition Unit 204, MTS Load cell 206 (capacity 22,000 lbf), connected to the MTS Data Acquisition unit with cables 208. The beams 210 were loaded at their third points. The internal linear variable differential transformer (LVDT) 212 in the actuator was used to control the test speed.

A cross-head displacement speed of 0.127 cm (0.05 in.)/min was used to provide a net deflection increase equal to 0.05 cm (0.02 in.)/min according to ASTM C1609 (ASTM 2010a) standard. The size of the beam 210 used was 15×15×53 cm (6×6×21 in.), in accordance with ASTM C1609 and ASTM C78 (ASTM 2010b) standards. The clear span length was 46 cm (18 in.). Specimens were rotated 90 degrees on their side with respect to the position as cast. Using four screws, a locally designed and fabricated metallic frame 214 was attached to the neutral axis of the concrete beam above the support points 216.

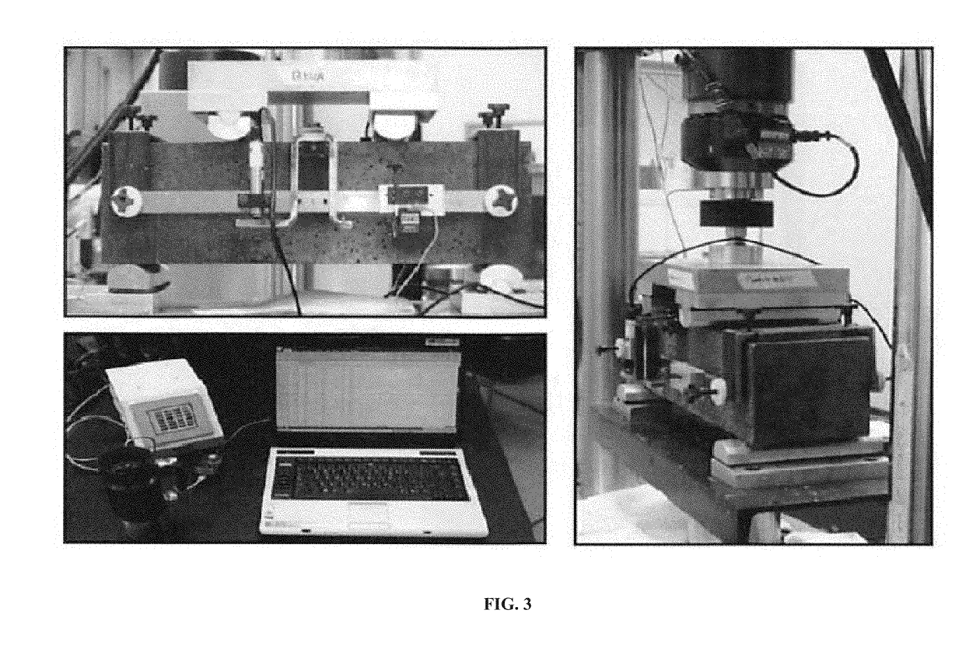

The data were collected using internal 204 and external 218 data acquisition units that are also shown on a photograph in FIG. 3. The external system was manufactured and assembled locally, and measured net deflection through two LVDTs 220 with a range of ±1.27 cm (0.5 in.) mounted on each side of the frame. The load was measured from a load cell with a maximum load capacity 222 of 13,640 kg (30,000 lbs) directly attached to the bottom of the cross-head. A 3-Hz data acquisition frequency was used to record and store simultaneous load and deflection signals onto a laptop.

The compression tests were conducted according to ASTM C39 (ASTM 2005), using a hydraulic machine under force control. This test only provided the ultimate failure load and corresponding compressive strength.

The values of fresh properties, which include temperature, slump, unit weight, and air content, are shown in Table 3 (a-c). It was found that at a crumb rubber content of 15%, slump was not affected. However, at higher crumb rubber contents of 35% and 50%, the slump reduced by 0.25 and 0.50 in. (0.6 and 1.27 cm), respectively. It was also found that at all crumb rubber content levels, a reduction in unit weight and an increase in air content were observed. As one of ordinary skill in the art would readily appreciate, the results showing an increase in the crumb rubber beyond 35% can result in a rapid drop in unit weight due to lower specific gravity of crumb rubber.

Mixtures that contained steel fiber at 0.64%, 0.89%, and 1.28% volume fractions shown in Table 3 (a-c) generally had lower slump and air content, but a higher unit weight. A slump reduction as high as 54% was observed at 1.28% steel fiber volume fractions; however, it was demonstrated that even with the high reduction in the slump, the mix was workable. The unit weight increased due to the higher specific gravity of steel fiber. However, the increase in the unit weigh has been found to be almost negligible, even at the highest steel volume fraction. Air content decreased with the addition of the steel fiber; however, a further increase in the steel fiber volume fractions did not result in additional reduction.

TABLE 3
Properties of Fresh Concrete
(a)

| Parameters | Batch 1 | Batch 2 | Batch 3 | Batch 4 | Batch 5 |
|---|---|---|---|---|---|
| Temperature, (° C.) | 23.5 | 22.5 | 22.5 | 22.5 | 22 |
| Slump, in. (1 = 2.54 cm) | 3.75 | 3.75 | 3.5 | 3.25 | 2.75 |
| Unit weight, lb/cu ft | 154.6 | 150 | 144.6 | 137.5 | 156.6 |
| (1 = 16 kg/m³) | | | | | |
| Air content, % | 2.1 | 2.5 | 3.1 | 4.4 | 1.6 |

(b)

| Parameters | Batch 6 | Batch 7 | Batch 8 | Batch 9 | Batch 10 |
|---|---|---|---|---|---|
| Temperature, (° C.) | 23 | 22 | 22.5 | 22 | 22.5 |
| Slump, in. (1 = 2.54 cm) | 2.25 | 1.75 | 2.5 | 0.75 | 0.25 |
| Unit weight, lb/cu ft | 157.4 | 158.9 | 150.7 | 151.2 | 153 |
| (1 = 16 kg/m³) | | | | | |
| Air content, % | 1.6 | 1.7 | 2.9 | 2.5 | 2.6 |

(c)

| Parameters | Batch 11 | Batch 12 | Batch 13 | Batch 14 | Batch 15 | Batch16 |
|---|---|---|---|---|---|---|
| Temperature, (° C.) | 23 | 22.5 | 22 | 21.5 | 22 | 22 |
| Slump, in. (1 = 2.54 cm) | 1.75 | 0.50 | 0.25 | 1.0 | 0.25 | 0.25 |
| Unit weight, lb/cu ft | 142.6 | 143 | 146 | 132 | 135.6 | 137 |
| (1 = 16 kg/m³) | | | | | | |
| Air content, % | 4.9 | 4.8 | 4.2 | 7.9 | 6.9 | 6.3 |

At 15% crumb rubber content, the addition of steel fiber to the mix increased the unit weight compared to that with only 15% crumb rubber. At 35% and 50% crumb rubber content, the first addition of steel fiber to the mix decreased the unit weight of the mix. However, additional increases in steel fiber volume fraction increased the unit weight. In general, all SFRRC mixtures exhibited higher air content compared with the PCC, RC, and SFRC mixtures. The lower unit weight and higher air content is an indication that SFRRC mixtures have a higher tendency to trap more air due to the presence of many ingredients in the mix.

Data on slump for SFRRC indicated a reduction with the increase of crumb rubber content or increase of steel fiber volume fraction at a given crumb rubber content. Despite the higher air content and lower unit weight and slump, a reasonable workability was observed for mixtures with 15% crumb rubber content and up to 1.28% steel volume fraction, and with 35% crumb rubber content and up to 0.89% steel fiber volume fractions.

The behavior of the PCC, RC, SFRC, and SFRRC beams, under third point loading at first-crack load, was investigated by considering the first-crack strength, toughness, modulus of elasticity, and load-deflection response. In addition, a parametric study was conducted to distinguish possible significant differences between the results, and to develop prediction models. Table 4 summarizes the net deflection values that were obtained from the test experiments.

TABLE 4
Net deflection Response
(a)

| Parameters | Batch 1 | Batch 2 | Batch 3 | Batch 4 | Batch 5 |
|---|---|---|---|---|---|
| First-crack net deflection, | 0.0019 | 0.0018 | 0.0020 | 0.0019 | 0.0020 |
| in. (1 = 2.54 cm) | | | | | |
| Percentage change | ^{a} | −5.3 | 5.3 | 0.0 | 5.3 |
| Net deflection at 50%^{b}, | 0.0008 | 0.0009 | 0.0012 | 0.0017 | 0.0008 |
| in. (1 = 2.54 cm) | | | | | |
| Percentage change | ^{a} | 12.5 | 50.0 | 112.5 | 0.0 |

(b)

| Parameters | Batch 6 | Batch 7 | Batch 8 | Batch 9 | Batch 10 |
|---|---|---|---|---|---|
| First-crack net deflection, | 0.0021 | 0.0022 | 0.0020 | 0.0021 | 0.0022 |
| in. (1 = 2.54 cm) | | | | | |
| Percentage change | 10.5 | 15.8 | 5.3 | 10.5 | 15.8 |
| Net deflection at 50%^{b}, | 0.0008 | 0.0008 | 0.0010 | 0.0010 | 0.0010 |
| in. (1 = 2.54 cm) | | | | | |
| Percentage change | 0.0 | 0.0 | 25.0 | 25.0 | 25.0 |

(c)

| Parameters | Batch 11 | Batch 12 | Batch 13 | Batch 14 | Batch 15 | Batch16 |
|---|---|---|---|---|---|---|
| First-crack net deflection, | 0.0021 | 0.0021 | 0.0023 | 0.0023 | 0.0023 | 0.0024 |
| in. (1 = 2.54 cm) | | | | | | |
| Percentage change | 10.5 | 10.5 | 21.1 | 21.1 | 21.1 | 26.3 |
| Net deflection at 50%^{b}, in. | 0.0013 | 0.0013 | 0.0013 | 0.0023 | 0.0020 | 0.0022 |
| (1 = 2.54 cm) | | | | | | |
| Percentage change | 62.5 | 62.5 | 62.5 | 187.5 | 150.0 | 175.0 |

^{a} Control mix.
^{b}This is in relation to PCC specimen when reached 50% of its first-crack load.

In general, RC beams exhibited an increase in net deflection compared to that at 50% of PCC First-crack load. The first-crack net deflection for RC beams did not show a similar increase due to the lower first-crack load. The SFRC beams experienced an increase in first-crack net deflection; however, without wishing to be bound by a theory it is believed that this increase cannot be attributed to an increase in flexibility. It is hypothesized that such increase can be the result of an increased in first-crack load, which allowed the specimen to reach a higher deflection.

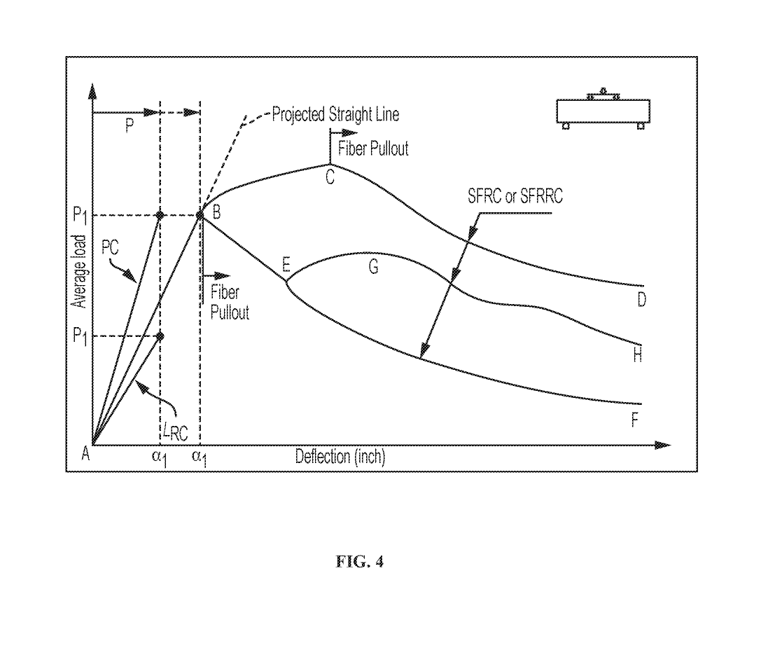

On the other hand, incorporation of crumb rubber in conjunction with steel fiber improved the deflection response of the composite at both first crack and 50% of the corresponding PCC first-crack load. To understand these results, a straight line was drawn along the ascending part of the load-deflection curve FIG. 4. The PL point was then defined as the first point of non-linearity, which allowed for a more objective determination. Table 5 (a-c) below presents the average first-crack load with the corresponding first-crack strength. A general increase in the first-crack strength was found with an increase in steel fiber volume fraction. Inclusion of steel fiber at 0.64% by volume of concrete did not cause a substantial change in the first-crack strength.

TABLE 5
First-Crack Load and Corresponding First-Crack Strength
(a)

| Parameters | Batch 1 | Batch 2 | Batch 3 | Batch 4 | Batch 5 |
|---|---|---|---|---|---|
| First-crack load, | 12,685 | 10,327 | 8,853 | 6,536 | 12,847 |
| lbf (2.2 kgf) | | | | | |
| First-crack strength, | 1,055 | 855 | 745 | 545 | 1,080 |
| psi (0.0069 MPa) | | | | | |
| Percentage change | ^{a} | −19.0 | −29.4 | −48.3 | 2.4 |

(b)

| Parameters | Batch 6 | Batch 7 | Batch 8 | Batch 9 | Batch 10 |
|---|---|---|---|---|---|
| First-crack load, | 13,106 | 13,131 | 10,727 | 11,182 | 11,597 |
| lbf (2.2 kgf) | | | | | |
| First-crack strength, | 1,125 | 1,135 | 900 | 935 | 1,010 |
| psi (0.0069 MPa) | | | | | |
| Percentage change | 6.6 | 7.6 | −14.7 | −11.4 | −4.3 |

(c)

| Parameters | Batch 11 | Batch 12 | Batch 13 | Batch 14 | Batch 15 | Batch16 |
|---|---|---|---|---|---|---|
| First-crack load, | 8,863 | 8,760 | 9,411 | 6,293 | 6,726 | 6,567 |
| lbf (2.2 kgf) | | | | | | |
| First-crack strength, | 740 | 755 | 795 | 525 | 565 | 570 |
| psi (0.0069 MPa) | | | | | | |
| Percentage change | −29.9 | −28.4 | −24.6 | −50.2 | −46.4 | −46.0 |

^{a} Control mix.

The SFRC beams with 1.28% steel fiber volume fraction did not exhibit an increase in strength compared with those with 0.64% steel fiber volume fraction. However, SFRRC beams with 15% crumb rubber content exhibited a benefit from adding steel fiber at all volume fractions. Again, without wishing to be bound by a theory, these results imply that the addition of steel fiber to a non-fibrous mix with lower design strength could exhibit a higher increase in mix strength over that added to high-strength concrete. In contrast, the addition of crumb rubber to low strength concrete mix would not exhibit a high reduction in strength, which does not illustrate the true effect on its strength.

Toughness measures the energy equivalent to the area under a given curve of applied load versus the resulting deformation from that load. The toughness at PL was extracted for all test series. The average toughness response of all test series is illustrated in Table 6 (a-c). It is understood that the average value was measured from three specimens per mix. It was found that SFRC specimens produced the highest toughness compared to the other series. Without wising to be bound by a theory, it is believed that such results are primarily due to the increased first-crack strength of these specimens over other specimens. Beams with a steel fiber volume fraction of 0.64%, 0.89%, and 1.28%, yielded increases in toughness by 4.8%, 12.4%, and 19.8%, respectively. Conversely, RC beams demonstrated a decrease in toughness by about 21.4%, 27.8%, and 49.3% at a crumb rubber content of 15%, 35%6, and 50%, respectively. Without wishing to be bound by a theory, the decrease in toughness in the RC specimens was attributed to the lower first-crack strength compared to that of PCC. The SFRRC beams with 15% crumb rubber and the inclusion of steel of fiber at 0.89% and 1.28% by total volume of concrete regained the matrix toughness that was lost by the addition of crumb rubber and exceeded that of PCC. It was found that the inclusion of crumb rubber in conjunction with steel fiber in the concrete mix indicated higher toughness compared to the RC.

TABLE 6
Average Toughness Response
(a)

| Parameters | Batch 1 | Batch 2 | Batch 3 | Batch 4 | Batch 5 |
|---|---|---|---|---|---|
| Toughness, lb-in. (0.138) | 12.05 | 9.47 | 8.70 | 6.10 | 12.63 |
| Percentage change | ^{a} | −21.4 | −27.8 | −49.3 | 4.8 |

(b)

| Parameters | Batch 6 | Batch 7 | Batch 8 | Batch 9 | Batch 10 |
|---|---|---|---|---|---|
| Toughness, lb-in. (0.138) | 13.54 | 14.44 | 10.73 | 11.74 | 12.76 |
| Percentage change | 12.3 | 19.8 | −10.9 | −2.6 | 5.9 |

(c)

| Parameters | Batch 11 | Batch 12 | Batch 13 | Batch 14 | Batch 15 | Batch16 |
|---|---|---|---|---|---|---|
| Toughness, lb-in. (0.138) | 9.31 | 9.20 | 10.66 | 7.13 | 7.85 | 7.88 |
| Percentage change | −22.7 | −23.6 | −11.5 | −40.8 | −34.8 | −34.6 |

^{a} Control mix.

As one of ordinary skill in the art would readily appreciate, the elastic modulus is an indication of flexibility of a material. The material tends to deform elastically (i.e., non-permanently) when a load is applied. This characteristic is defined as the slope of the ascending branch of the stress-strain curve in the linear phase. A stress-strain curve has the same shape as a load-deflection curve; however, the two are scaled differently. Thus, elastic modulus was extracted from the load-deflection curve for all test series. Table 7 (a-c) presents the average elastic modulus for all test series. The results show that RC mixtures produced the lowest elastic modulus. In these exemplary aspects, it was found that crumb rubber content and elastic modulus are proportional. The elastic modulus of mix that contained crumb rubber decreased by about 16.6%, 33.3%, and 50% for 15%, 35%, and 50% crumb rubber content, respectively. The SFRC beams exhibited similar behavior to that of the control mix. This finding indicates that stresses are supported only by the matrix until the first crack. It was further shown that SFRRC beams showed a different reaction when crumb rubber was included in conjunction with steel fiber; specifically, this mix exhibited lower elastic modulus. Without wishing to be bound by a theory, it is believed that the inclusion of crumb rubber can play a dominate role in determining composite elastic properties.

TABLE 7
Average Elastic Modulus Response × (10⁶).
(a)

| Parameters | Batch 1 | Batch 2 | Batch 3 | Batch 4 | Batch 5 |
|---|---|---|---|---|---|
| Elastic modulus, | 6 | 5 | 4 | 3 | 6 |
| psi (0.069 MPa) | | | | | |
| Percentage change | ^{a} | 16.6 | 33.3 | 50 | 0 |

(b)

| Parameters | Batch 6 | Batch 7 | Batch 8 | Batch 9 | Batch 10 |
|---|---|---|---|---|---|
| Elastic modulus, | 6 | 6 | 6 | 5 | 5 |
| psi (0.069 MPa) | | | | | |
| Percentage change | 0 | 0 | 0 | 16.6 | 16.6 |

(c)

| Parameters | Batch 11 | Batch 12 | Batch 13 | Batch 14 | Batch 15 | Batch16 |
|---|---|---|---|---|---|---|
| Elastic modulus, | 4 | 4 | 4 | 3 | 3 | 3 |
| psi (0.069 MPa) | | | | | | |
| Percentage change | 33.3 | 33.3 | 33.3 | 50 | 50 | 50 |

^{a} Control.

Table 8 and Table 9 illustrate a summary of the analysis. It was shown that for SFRC and RC, a correlation between the dependent and independent variable can be found and can be represented the R value. An attempt to build a prediction model for SFRC and RC test beams were made. These prediction models were developed for SFRC and RC and represented the dependent variable (first-crack load) by about 65 and 97%, respectively. It was shown that these two models can predict the dependent variable, p=0.02 and p=0.00 for SFR and RC, respectively. The two prediction models can be presented by Eqs. (1) and (2):

First-crack load (psi)=(B×2.844)+12,676.818 (1)

First-crack load (psi)=−(A×116.186)+12,505.10 (2)

where A=crumb rubber content (%); and B=steel fiber dosage (lbs/yd³).

TABLE 8
Linear Regression First-Crack Load Model Summary -SFR

| Parameters | B | P-value |
|---|---|---|
| (Constant) | 12,677.171 | 0 |
| Steel dosage | 2.85 | 0.002 |

Note:
R = 0.801, R Square = 0.642.

TABLE 9
Linear Regression First-Crack Load Model Summary -RC

| Parameters | B | P-value |
|---|---|---|
| (Constant) | 12,505.101 | 0.000 |
| Crumb rubber content | −116.187 | 0.000 |

Note:
R = 0.985, R Square = 0.970.

For SFRRC, there were two independent (crumb rubber and steel fiber contents) and two dependent (first-crack load and first-crack deflection) variables. Hence, a two-step multiple regression model was developed. The first model, allows to predict a mix first-crack load at a given crumb rubber and steel fiber content. The second model, allows predicting a mix first-crack net deflection. Without wishing to be bound by a theory it was assumed that the inclusion of steel fiber in conjunction with crumb rubber would increase the composite first-crack load, thus allowing for a higher first-crack deflection.

Based on this assumption, first-crack load data were included as a third independent variable in the first-crack net deflection prediction model. The interaction between each of the independent variables was also considered in the development of each model. A normality test was carried out graphically by plotting the expected versus the observed data points. Results revealed a strong correlation between the dependent and independent variables. The prediction models were found to represent the dependent variable (first-crack load and net deflection) by about 98 and 95%, respectively.

These two models were also found to predict the dependent variable, p=0.00, for first-crack load and net deflection, respectively. The two prediction models can be represented by Eqs. (3) and (4) as shown below. Table 10 shows a summary of the multiple-regression analysis based on these models.

Y₁=−(124.250×A)+(3.42×B)+12,638.8 (3)

Y₂=−(6.067×10×A)−(6.972×10⁷×B)

+(1.494×10⁷×C)+(2.593×10⁹×A×Y₁)

+(1.007×10¹⁰×B×Y₁)+(2.699×10⁸×A×B) (4)

where A=crumb rubber content (%); B=steel fiber dosage (lbs/yd³); Y₁=first-crack load (lbf); and Y₂=first-crack net deflection or net deflection at any point on the load deflection curve (in.).

TABLE 10
Multiple-Regression Analysis Summary-SFRRC

| Item | Parameters | B | P-Value |
|---|---|---|---|
| First-crack | (Constant) | 12,638.816 | 0 |
| load model^{a} | Crumb rubber content | −124.25 | 0 |
| | Steel Dosage | 3.421 | 0 |
| First-crack net | Intercept | 0 | 0 |
| deflection or | Crumb rubber content | −6.07 × 10⁷ | 0.295 |
| net deflection | Steel fiber dosage | −6.97 × 10⁷ | 0 |
| at any load^{b} | First crack load or load at any | 1.44 × 10⁷ | 0 |
| | point | | |
| | Crumb rubber content × first | 2.58 × 10⁹ | 0 |
| | crack load or load at any | | |
| | point | | |
| | Steel fiber dosage × first | 1.01 × 10¹⁰ | 0 |
| | crack load or load at any | | |
| | point | | |
| | Steel fiber dosage × crumb | 2.70 × 10⁸ | 0 |
| | rubber content | | |

^{a}R = 0.989, RSquare = 0.977.
^{b}R Square = 0.954.

It was found that in flexural load-deflection response tests SFRRC beams with 15% crumb rubber content exhibited a benefit by adding steel fiber at all volume fractions. Again, without wishing to be bound by a theory this finding can imply that the addition of steel fiber to a non-fibrous mix with lower design strength would exhibit an increase in strength over that added to high-strength concrete. Toughness results indicated that SFRRC beams with 15% crumb rubber and the inclusion of steel of fiber at 0.89% and 1.28% by total volume of concrete gained back the matrix toughness that was lost with the addition of crumb rubber and exceeded that of PCC. In general, it was found that inclusion of crumb rubber in conjunction with steel fiber in the concrete mix indicated higher toughness compared with RC. The modulus of elasticity of SFRRC beams clearly showed that the inclusion of crumb rubber, in conjunction with steel fiber, exhibited a lower elastic modulus. Without wishing to be bound by a theory it is believed that the inclusion of crumb rubber s can play a dominate role in determining the composite's elastic property.

Compressive strength test results of SFRRC cylindrical specimens indicated that the failure mode considerably changed from fragile to ductile. Because of a bridging effect of the fibers and higher elasticity of crumb rubber, the cylindrical specimens did not crush, but instead held their integrity to the end of the test. SFRRC cylinders with 15% and 35% crumb rubber indicated a higher strength with the increase in steel fiber volume fraction. This concurs with results obtained in bending tests. Flexural first-crack strength for SFRRC beams with crumb rubber content up to 35% was about 15%-17% of the compressive strength of a comparable mix, and about 19%-20% of the compressive strength at 50% crumb rubber content and steel fiber at any volume fraction.

At 15% crumb rubber content, the addition of steel fiber to the mix increased the unit weight of the mix compared with that with only 15% crumb rubber. At 35% and 50% crumb rubber content, the first addition of steel fiber to the mix decreased the unit weight of the mix. However, further increases in the steel fiber volume fraction increased the unit weight, although this was still lower than that with 35% and 50% crumb rubber only. All SFRRC mixtures exhibited higher air content compared with the PCC, RC, and SFRC mixtures. Without wishing to be bound by a theory, the lower unit weight and higher air content can serve as an indication that SFRRC mixtures had a higher tendency to trap more air due to the many ingredients in the mix. Data of slump for SFRRC mixes also indicated a reduction with the increase of crumb rubber content and with the increase in steel liber volume fraction at a given crumb rubber content. Despite the higher air content and lower unit weight and slump, a reasonable workability was observed for mixtures with 15% crumb rubber content and up to 1.28% steel volume fraction, and with 35% crumb rubber content and up to 0.89% steel fiber volume fractions.

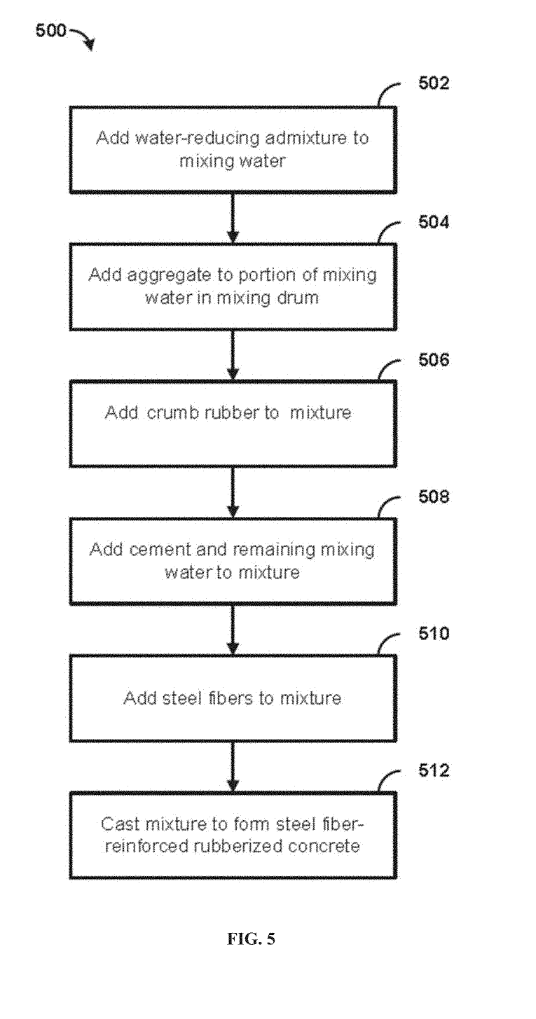

FIG. 5 is a flowchart 500 describing a method for mixing steel fiber-reinforced rubberized concrete. Beginning with step 502, a water-reducing admixture is added to an amount of mixing water. The water-reducing admixture can include, for example, PolyHeed 997, or another admixture meeting ASTM C494 (ASTM 2008a) requirements for Type A water-reducing admixtures. Particularly, additional admixtures can be required where small batches, e.g. five cubic yards or less, are made. An exemplary BASF PS 1466 high-range admixture or another admixture can be included. In these exemplary aspects, this admixture of another admixture can be added in an amount of about twelve ounces per cubic yard, or another amount.

Next, in step 504, aggregate is added to a portion of the mixing water. The aggregate can include aggregate components of cement, such as Portland cement. The aggregate can include coarse aggregate, intermediate aggregate, fine aggregate, or a combination thereof. In an aspect, coarse aggregate, intermediate aggregate, and fine aggregate are delineated according to one or more size thresholds. In some exemplary aspects, the coarse aggregate and the intermediate aggregate are added together. For example, in an aspect, coarse aggregate may have a maximum size of 2.54 cm, intermediate aggregate may have a maximum size of 1.27 cm, and fine aggregate may have a maximum size of 0.475 cm. The aggregate can be added to the mixing water in a mixing drum to create a mixture. In an aspect, the mixing drum can be included in a transport truck during mixing. In an aspect, the interior mixing drum or other components of the transport truck can be dampened prior to adding components of the steel fiber-reinforced rubberized concrete to avoid moisture absorption during mixing. In an aspect, mixture can be mixed in the mixing drum for one minute.

In step 506, fine aggregate and crumb rubber is added to the mixture produced in step 504. For example, in some aspects, in step 506 sand and crumb rubber can be added to the mixture produced in step 504. In this exemplary aspect, the amount of crumb rubber can be added such that the final steel fiber-reinforced rubberized concrete product comprises about 15% crumb rubber by total volume. In another aspect, the amount of crumb rubber can be added such that the final steel fiber-reinforced rubberized concrete product comprises about 35% crumb rubber by total volume. In an aspect, mixture can be mixed in the mixing drum for two minutes. Next, in step 508, cement and the remaining mixing water are added to the mixture. In an aspect, after adding the cement and remaining mixing water, the mixture can be mixed in the mixing drum for three minutes, rested for three minutes, and then mixed for an additional two minutes. Although the addition of crumb rubber is described as being performed prior to the addition of steel fibers as set forth in step 510, it is understood that any amount of the crumb rubber can be added after the steel fibers slowly at the end of the mixing process.

Next, in step 510, steel fibers can be added to the mixture. In an aspect, the steel fibers can be added by sprinkling by hand, i.e. a rain of individual fibers. In an aspect, the steel fibers can be added such that the final steel fiber-reinforced rubberized concrete product comprises about 0.89% steel fibers by total volume. In another aspect, the steel fibers can be added such that the final steel fiber-reinforced rubberized concrete product comprises about 1.28% steel fibers by total volume. For example, in an aspect, the final steel fiber-reinforced rubberized concrete product may comprise about 35% crumb rubber and about 0.89% steel fibers. As another example, in an aspect, the final steel fiber-reinforced rubberized concrete product may comprise about 15% crumb rubber and about 1.28% steel fibers. In an aspect, the mixture can be mixed for additional four or more minutes in the mixing drum after adding all steel fibers. In aspects in which the mixing process occurs in a mixing drum of a transport vehicle, the mixing drum should be rotated at a slow speed to avoid further air entrapment. In step 512, after mixing, the mixture is cast to produce the final steel fiber-reinforced concrete product. In an aspect, this can include applying short interval of vibration to distribute material to the edge of forms, corners, and around any irregularities. In an aspect, the interval can be less than five seconds, such as two to three second intervals. In an aspect, internal vibration can assist in surface consolidation and raising “creme” to the surface. Final finishing of the surface needs to be completed sooner than standard PCC as it can become difficult to complete due to steep fiber interlocking.

While the methods and compositions have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and compositions pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A concrete mixture, comprising:
an amount of coarse aggregate;
an amount of cement;
an amount of crumb rubber; and
an amount of steel fibers.

2. The concrete mixture of claim 1, further comprising an amount of intermediate aggregate or an amount of fine aggregate.

3. The concrete mixture of claim 2, wherein the fine aggregate comprises aggregate of having a maximum size of about 0.475 cm, and the intermediate aggregate comprises aggregate having a maximum size of about 1.27 cm.

4. The concrete mixture of claim 1, further comprising an amount of water reducing admixture.

5. The concrete mixture of claim 1, wherein the amount of crumb rubber comprises about 15 percent of the concrete mixture by total volume.

6. The concrete mixture of claim 5, wherein the amount of steel fiber comprises about 0.89 percent of the concrete mixture by total volume.

7. The concrete mixture of claim 5, wherein the amount of steel fiber comprises about 1.28 percent of the concrete mixture by total volume.

8. The concrete mixture of claim 1, wherein the amount of crumb rubber comprises about 35 percent of the concrete mixture by total volume.

9. The concrete mixture of claim 8, wherein the amount of steel fiber comprises about 0.89 percent of the concrete mixture by total volume.

10. The concrete mixture of claim 8, wherein the amount of steel fiber comprises about 1.28 percent of the concrete mixture by total volume.

11. A method for creating a concrete product, comprising:
adding course aggregate and a portion of an amount of mixing water to create a mixture;
adding crumb rubber to the mixture;
adding cement and a remainder of the amount of mixing water to the mixture; and
adding steel fibers to the mixture.

12. The method of claim 11, further comprising adding a water-reducing admixture to the amount of mixing water prior to addition to the mixture.

13. The method of claim 11, further comprising mixing the mixture in a mixing drum.

14. The method of claim 11, further comprising casting the mixture.

15. The method of claim 11, further comprising adding an amount of intermediate aggregate or an amount of fine aggregate to the mixture.

16. The method of claim 15, wherein the amount of intermediate aggregate or the amount of fine aggregate are added to the mixture with the coarse aggregate.

17. The method of claim 11, wherein the concrete product comprises about 15 percent crumb rubber by total volume.

18. The method mixture of claim 11, wherein the concrete product comprises about 0.89 percent steel fiber or 1.28 steel fiber by total volume.

19. The method of claim 11, wherein the concrete product comprises about 35 percent crumb rubber by total volume.

20. The method mixture of claim 19, wherein the concrete product comprises about 0.89 percent steel fiber or 1.28 steel fiber by total volume.
